(19) United States
(12) Patent Application Publication
(10) Pub. No.: US 2009/0019656 A1
(43) Pub. Date: Jan. 22, 2009

(54) Multi-phase hygienic cleansing system and skin care device

(76) Inventor: Derrick Mitchell, Norcross, GA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/880,025

(22) Filed: Jul. 19, 2007

(51) Int. Cl. A47K 7/02; B32B 3/10

(52) U.S. Cl. 15/208; 428/138

(57) ABSTRACT

A multi-phase hygienic cleansing system and skin care device, comprising an inter-related network of cleansing features defined by an openweave fabric attached to a cloth, wherein the openweave fabric is further structurally defined by a plurality of essentially tightly-woven or solid fabric regions interspersed in a grid-like arrangement about a plurality of openings, such that the tightly-woven or solid fabric regions function to absorb moisture and dirt, and to visually identify successful cleansing, such that the grid-like arrangement of the openings proximate the solid regions function to exfoliate and scrub, and such that the plurality of openings function to receive particulate matter and dead skin debris from the cleansing surface, removing same from risk of reapplication to the body.

### TECHNICAL FIELD

The present invention relates generally to personal hygiene body cleansing devices, and more specifically to a multi-phase hygienic cleansing system and skin care device, wherein a first phase of a plexus system removes and traps dirt, grease, grime and dead skin, with visible confirmation of successful cleansing, and wherein a second phase polishes the skin.

### BACKGROUND OF THE INVENTION

Skin cleansing tools and techniques abound, from simple, traditional washcloths to powered, handheld scrubbers. Each has been developed to accomplish a goal and solve a problem previously unsolved. However, each is disadvantageous in view of the present invention.

First, traditional cloth washcloths have been found to be desirable by some because they are soft and conformable to variably-shaped body parts, capable of distributing lather, launderable, reusable, and inexpensive to manufacture. Some specialized washcloth textiles include dual or blended layers, fabricated to enhance moisture-absorbency and to impart anti-microbial properties. Such cloths can effectively move moisture away from the skin. However, such soft fabric is frequently inadequate at removing tough grime, grease, or the like, and does not easily exfoliate the skin, if at all. On the other hand, loofah provides excellent exfoliation, yet is generally not conformable to small body spaces, nor soft enough for utilization on all body areas.

In order to allow for more conformability, cleansing tools have been developed using nylon netting, or hydrophobic diamond-mesh scrim, such as hanging ball and/or tubular configurations, wherein the netting has similar performance characteristics to loofah, yet with a greater ability for adaptation to a variety of body surfaces. Such devices, however, are non-absorbent, tend to collect dirt and debris, and can become coated and/or clogged with heavy dirt, grease, or grime during use, resulting in the disadvantageous delivery of unsanitary debris over the body surface.

Some cleansing devices, such as mitts, have been proposed, wherein open netting is provided on the exterior in order to retain a bar of soap therein while retaining lathering access thereto. While the net strands of such a mitt may arguably provide some scrubbing assistance, the minimal surface area defined by each strand disadvantageously limits beneficial exfoliation, and the mitt or glove design limits areas of use. Further, debris that may be removed during the washing is apparently held proximate the surface of the soap until rinsed or otherwise re-deposited onto the user.

Therefore, it is readily apparent that there is a need for a multi-phase hygienic cleansing system and skin care device, wherein a conformable, absorbent configuration facilitates effective use, wherein one surface effectively removes dirt and debris from the body surface, both trapping it within the device to prevent reapplication and providing a visible indication of achieved cleanliness, and wherein another surface effectively polishes the freshly cleaned skin.

### BRIEF SUMMARY OF THE INVENTION

Briefly described, in a preferred embodiment, the present invention overcomes the above-mentioned disadvantages and meets the recognized need for such a system and method by providing a multi-phase hygienic cleansing system and skin care device, comprising an interrelated network of cleansing features defined by an openweave fabric attached to a terry cotton cloth, wherein the openweave fabric is further structurally defined by a plurality of essentially tightly-woven or solid fabric regions interspersed in a grid-like arrangement about a plurality of openings, such that the tight woven or solid fabric regions function to absorb moisture and dirt, first darkening, and ultimately visibly lightening upon successful cleansing, such that the grid-like arrangement of the openings proximate the solid regions function to exfoliate and scrub, and such that the plurality of openings function to receive particulate matter and dead skin debris from the cleansing surface, thereby essentially removing same from risk of reapplication to the body.

According to its major aspects and broadly stated, the present invention in its preferred form is a multi-phase hygienic cleansing system and skin care device comprising a washcloth, such as a terry cloth or cotton washcloth, having a woven polymer mesh sheet, such as porthole polyester or nylon mesh, attached to and substantially covering one major surface of the washcloth. The polymer mesh sheet preferably provides a scrubbing surface for use in removing dirt, oil, dead skin, or the like during use. The other opposing major surface is preferably uncovered, and preferably provides a soft surface for polishing the skin and absorbing oils, with the space between the opposing major surfaces trapping removed dirt and other debris.

More specifically, the present invention is a multi-phase hygienic cleansing system and skin care device, comprising a soft, washable cleansing tool with a mesh-like partial covering, wherein the mesh weave is configured to define a particularly preferred balance of apertures and woven surface area, and wherein the weave is aesthetically designable, such as with personalization and/or desirable patterns. The dual nature of the preferred single-ply expanse of woven polymer fiber mesh sheet, with apertures separated by areas of woven sheet, as attached to and substantially covering one major surface of the soft, washable cloth, allows for debris removed by scrubbing with the mesh sheet to pass therethrough and be trapped by the washcloth. Thus, the preferably cotton washcloth, disposed immediately adjacent to the mesh sheet, traps the dirt, oil, and dead exfoliated skin such that it is not re-deposited on the user's skin, such as during rinsing. The mesh further preferably resists stains such that a user can visually inspect the mesh sheet to determine whether dirt or other material has been removed during use. The opposing expanse of soft, washable cloth offers a surface for washing, as well as polishing a user's skin to its natural complexion.

The multi-phase hygienic cleansing system and skin care device, preferably known as DERMICLOTH, provides an interwoven structure, or plexus system, wherein the two phases of soft, washable solid weave and open weave fabric cooperatively function to avoid smearing of dirt, grease, or grime, and instead effectively peel away dead skin, absorb excess oils, and polish the surface of the skin. Moreover, during use, the solid areas of the open weave layer visibly darken upon contact with soiled skin, absorbing dirt, grease, or grime, and noticeably whitening as cleansing is complete due to easily effective rinsing of the soiled areas coupled with and facilitated by the retention of particulate matter within the DERMICLOTH interior, eliminating the guessing game as to when washing is accomplished.

The preferred DERMICLOTH multi-phase hygienic cleansing system and skin care device of the present invention can, with repeated use over time, reduce the visible appearance of scars, blemishes, razor bumps, and even fine wrinkles of aging skin, and can also be helpful for managing dandruff. Further, the preferred DERMICLOTH skin care system, when used with soap and water, can enhance elimination of germs, fungus and bacteria that may otherwise remain following use of a traditional washcloth, thus functioning as a true hygienic cleansing system.

Additionally, with consistent use over time of the preferred DERMICLOTH multi-phase hygienic cleansing system and skin care device of the present invention, user effort at cleansing the body may decrease, wherein the DERMICLOTH may reduce necessary shower and/or bath time, thereby offering an environmentally friendly system and device that may reduce fresh water consumption.

The plexus configuration defined by the multi-phase hygienic cleansing system and skin care device of the present invention may also be extended to adaptation to a drying device, in addition to or in lieu of a wet cleansing device. As an accompaniment to a wet cleansing device, such a drying device may provide a means of being extraordinarily clean. That is, when drying off, the DERMITOWEL would preferably perform essentially the same functions as the DERMICLOTH, with the addition of the extra cleansing via absorbance of water beads after showering or bathing to enhance the overall level of cleanliness.

Accordingly, a feature and advantage of the present invention is its ability to configured in a plurality of user friendly designs, shapes, and styles, each offering a two-phase plexus system that is conformable to all variably-shaped body regions for effective cleansing thereof.

Another feature and advantage of the present invention is its ability to function in cooperation with soap and water to enhance elimination of germs, fungus, and bacteria relative to an ordinary washcloth.

Yet another feature and advantage of the present invention is its ability to reduce the amount of time required to properly cleanse the body.

Still another feature and advantage of the present invention is its ability to reduce energy consumption and conserve water by reducing the quantity of heated bathing water utilized.

Yet another feature and advantage of the present invention is its ability to adapt to a wide variety of child and user-friendly shapes, styles, and sizes, such as, for exemplary purposes only, animals, cars, boats, cartoon characters, clouds, stars, moons, buildings, houses, footballs, baseballs, sports or team-related shapes, or the like.

Still yet another feature and advantage of the present invention is its ability to reduce the appearance of razor bumps and other skin irritations.

Yet another feature and advantage of the present invention is its ability to assist in the treatment of dandruff.

Yet still another feature and advantage of the present invention is its ability to provide an indicator surface for displaying the dirt, dead skin, grease and grime for the user's observation, as it is being removed and absorbed into the cleansing device.

Still another feature and advantage of the present invention is its ability to polish the skin and absorb oily residue.

Yet another feature and advantage of the present invention is its suitability for application to prevention and treatment of pseudofolliculitis, or in-grown hairs, via clearance of skin pores.

Another feature and advantage of the present invention is its ability to accommodate a variety of décor styles, via variation in colors, and designs of a plurality of geometric shapes, such as oval, circular, and triangular shapes.

Still another feature and advantage of the present invention is its ability to display a custom design openweave pattern, such as, for exemplary purposes only, animate and inanimate objects, animals, automobiles, train, airplanes, buildings, cartoon and other licensed characters and mascots, footballs, baseballs and other sports-related paraphernalia, alphabet and number displays, monograms, logos, trademarks, phrases, and/or essentially any other desirable pictorial or written display in one or more languages.

These and other objects, features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a partial cut-away plan view of a multi-phase hygienic cleansing system and skin care device, according to a preferred embodiment of the present invention;

FIG. 2 is a cross-sectional view of the multi-phase hygienic cleansing system and skin care device of FIG. 1;

FIG. 3 is a plan view of the multi-phase hygienic cleansing system and skin care device of FIG. 1; and

FIG. 4 is a multi-phase hygienic cleansing system and skin care device, according to an alternate embodiment of the present invention, showing a shape variation.

### DETAILED DESCRIPTION OF THE PREFERRED AND ALTERNATIVE EMBODIMENTS

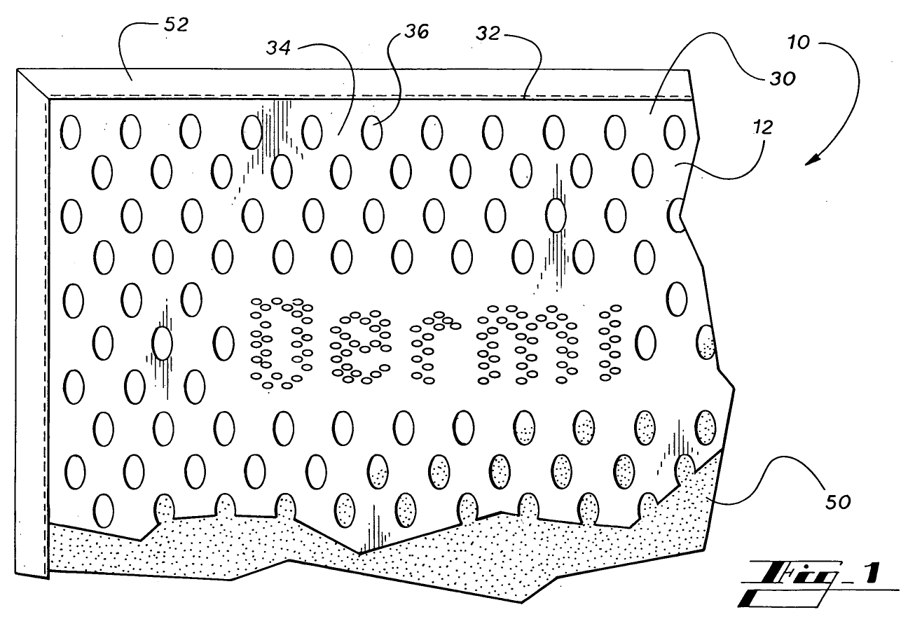

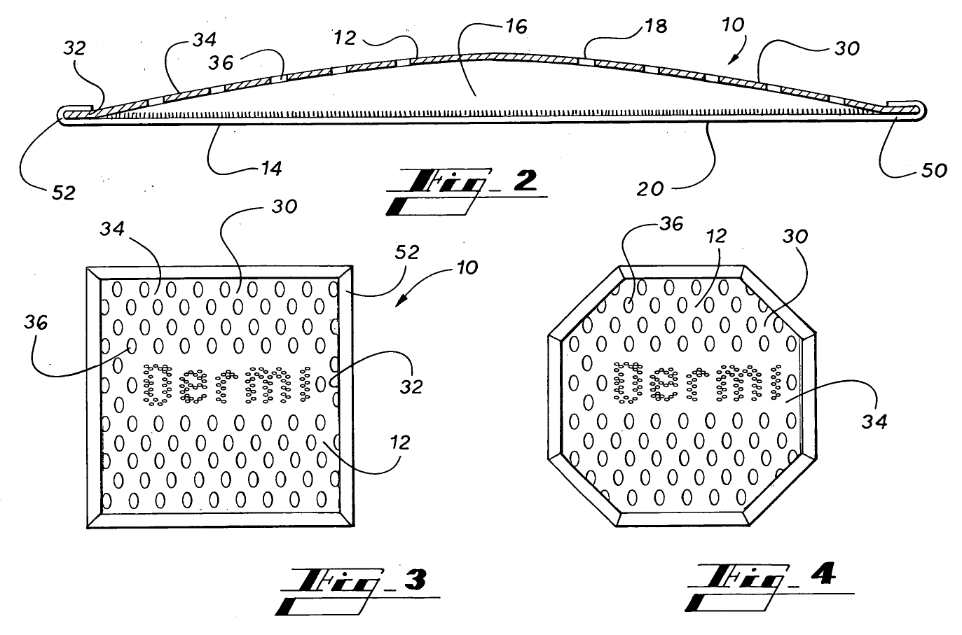

In describing the preferred and alternate embodiments of the present invention, as illustrated in FIGS. 1-4, specific terminology is employed for the sake of clarity. The invention, however, is not intended to be limited to the specific terminology so selected, and it is to be understood that each specific element includes all technical equivalents that operate in a similar manner to accomplish similar functions.

The present invention in a preferred embodiment is a multi-phase hygienic cleansing system and skin care device 10 comprising an interrelated network of cleansing features in a conformable, absorbent configuration, preferably defined by openweave member 30 and solidweave member 50, wherein openweave member 30 and solidweave member 50 are preferably securely attached together proximate respective peripheral boundaries 32 and 52.

Preferably, openweave member 30 defines first external surface area 12 of multi-phase hygienic cleansing system and skin care device 10, wherein first external surface area 12 is adapted to effectively remove dirt, grime, grease, and other debris from a body surface. In the preferred configuration, openweave member 30 is a fabric, preferably structurally defined by plurality of essentially tight woven, or solid, fabric regions 34 interspersed in a preferred grid-like arrangement about plurality of openings 36, such that plurality of tight woven regions 34 providing a visible indication of achieved cleanliness during use via absorbance of moisture and dirt, thus first darkening, and ultimately visibly lightening upon successful cleansing. It is particularly noted that openweave member 30 is aesthetically designable, such that the orientation of plurality of tight woven regions 34 and/or of plurality of openings 36 is configurable, essentially via the weave, to display a desired pattern, image, personalization, or the like, such as, for exemplary purposes only, animate and inanimate objects, trains, airplanes, automobiles, boats, buildings, licensed characters and mascots, sports-related equipment such as footballs and baseballs, alphabet and number displays, monograms, logos, trademarks, phrases, and/or essentially any other desirable pictorial or written display in one or more languages.

Openweave member 30 is preferably formed from woven polymer mesh sheeting, such as porthole polyester or nylon; however, it should be recognized that other suitable natural and/or synthetic materials could be utilized as long as the structural conformation and performance of first exterior surface area 12, specifically as related to the preferred balance of plurality of tight woven regions 34 and interspersed plurality of openings 36, remains. Thus, openweave member 30 is preferably formed from woven polymer fibers, with plurality of openings 36, generally large-scale apertures, formed therein, separated by unbroken sections of woven sheet as defined by plurality of tight woven regions 34. That is, the preferred relationship of plurality of openings 36 proximate plurality of tight woven regions 34 is configured to function for exfoliation and scrubbing. Further, the preferred dimension and concentration of plurality of openings 36 relative to the overall dimension of openweave member 30 preferably facilitates the receipt and passage of particulate matter and dead skin debris from the cleansing surface through plurality of openings 36, as will be further discussed hereinbelow.

Preferably, solidweave member 50 defines second external surface area 14 of multi-phase hygienic cleansing system and skin care device 10, wherein second external surface area 14 is adapted to effectively polish the skin. Solidweave member 50 is preferably formed from terry cotton cloth; however, it should be understood that other suitably soft and absorbent solidweave fabrics could be utilized, such as, for exemplary purposes only, microfiber or chamois.

Referring now to FIG. 2, the preferred secure arrangement of openweave member 30 and solidweave member 50 proximate respective peripheral boundaries 32 and 52 defines interior compartment 16 of multi-phase hygienic cleansing system and skin care device 10. Preferably, interior compartment 16 is peripherally defined via peripheral boundaries 32 and 52 of openweave member 30 and solidweave member 50, respectively. Entry wall 18 of interior compartment 16 is preferably defined by openweave member 30, coincidentally with definition of first external surface area 12 of multi-phase hygienic cleansing system and skin care device 10. Barrier wall 20 of interior compartment 16 is preferably defined by closeweave member 50, coincidentally with definition of second external surface area 14 of multi-phase hygienic cleansing system and skin care device 10. This preferred configuration for interior compartment 16 preferably facilitates the receipt of particulate matter and dead skin debris therewithin, via plurality of openings 36 in openweave member 30, and the trapping of such particulates within interior compartment 16 via barrier wall 20, whereby the trapped particulates are essentially prevented from reapplication to the body surface.

Thus, multi-phase hygienic cleansing system and skin care device 10, preferably known as DERMICLOTH, comprises two phases. Phase one, i.e. closeweave member 50, is preferably a cotton base washcloth. Phase two, i.e. openweave member 30, is preferably a synthetic polymer fabric, typically porthole polyester or nylon mesh with a coordinating design relative to closeweave member 50. Upon preferred sewing together of the two phases, e.g. openweave member 30 and closeweave member 50, the preferred plexus system is defined. Although sewing is preferred, it should be understood that the two phases could be attached together by any suitable means, such as, for exemplary purposes only, quilting, fusing, melding, weaving, or the like.

Multi-phase hygienic cleansing system and skin care device 10 is preferably peripherally dimensioned much as a traditional washcloth. However, it should be noted that other peripheral dimensions could be utilized, such as for adaptation to a drying device (not shown) dimensioned much like a bath towel. Additionally, peripheral dimensions could be utilized to define a plurality of user and child friendly designs, shapes, and styles, such as that shown in FIG. 4, and, such as, for exemplary purposes only, animals, cars, boats, cartoon characters, clouds, stars, moons, buildings, houses, footballs, baseballs, sports equipment, or the like, and/or plurality of geometric shapes, such as oval, circular, and triangular shapes, or the like.

Further, openweave member 30 and/or closeweave member 50 may include images thereon, such as via printing, painting, embroidering, weaving, and any other suitable technique.

According to the preferred use of multi-phase hygienic cleansing system and skin care device 10, a user first preferably uses first external surface 12, as defined by openweave member 30, for scrubbing the skin by moving device 10 across the surface of the skin, wherein first external surface 12 removes dead skin, dirt, oil, grease and the like from the user's body. Thereafter, a user preferably uses second external surface 14, as defined by solidweave member 50, for polishing the skin by moving device 10 across the surface of the skin, wherein second external surface 14 buffs the surface of the skin and absorbs undesirable oily residue, as needed.

As multi-phase hygienic cleansing system and skin care device 10 is used, the user will notice that after some period of washing, first external surface 12, as defined by openweave member 30, essentially ceases to darken following contact with the user's body, remaining whiter during use, such that the user is visually notified that cleansing is complete. That is, during use, openweave member 30 absorbs the dead skin, oil, grease and grime and darkens, thereby allowing the user to actually see the dirt as it is being removed from the body, and subsequently lightens as the body becomes clean and as dirt and the like are rinsed and eliminated.

Because of the effectiveness of the cleansing system, DERMICLOTH preferably reduces the amount of time required to properly cleanse the body during subsequent cleanings, indirectly functioning as a money saving tool by lowering water consumption and decreasing the energy required to heat wash water, wherein continued, repeated use increases such beneficial realization and renders body cleansing even more easy and effective.

In an alternate embodiment, DERMICLOTH could be extended to wash gloves, mittens, back scrubbers, and the like; however, it is recognized that such configurations can disadvantageously limit the conformability the cleansing system and device.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A multi-phase skin care device, comprising:
an openweave fabric; and
a solidweave cloth,
wherein said openweave fabric is aligned proximate a first surface of said solidweave cloth, wherein a peripheral edge of said opening weave fabric is attached to said solidweave cloth proximate a peripheral edge of said first surface of said solidweave cloth, and
wherein said openweave fabric is structurally defined by a plurality of essentially tightly woven, essentially solid fabric regions interspersed in a grid-like arrangement about a plurality of openings.

2. The multi-phase skin care device of claim 1, wherein said peripheral edge of said openweave fabric is attached to said solidweave cloth also proximate a peripheral edge of said openweave fabric.

3. The multi-phase skin care device of claim 1, wherein said grid-like arrangement of said plurality of essentially tightly-woven, essentially solid fabric regions interspersed about said plurality of openings is configured to define a design selected from the group consisting of numbers, letters, inanimate objects, animate beings, symbols, logos, animals, cars, boats, cartoon characters, clouds, stars, moons, buildings, houses, footballs, baseballs, sporting goods and monograms within the weave of said openweave fabric.

4. The multi-phase skin care device of claim 1, wherein a periphery of said openweave fabric and a periphery of said solidweave cloth are dimensioned to define a washcloth.

5. The multi-phase skin care device of claim 1, wherein a periphery of said openweave fabric and a periphery of said solidweave cloth are dimensioned to define a bath towel.

6. The multi-phase skin care device of claim 1, wherein a periphery of said openweave fabric and a periphery of said solidweave cloth are dimensioned to define a geometric shape.

7. The multi-phase skin care device of claim 1, wherein said openweave fabric and said solidweave cloth are configured to define a shape selected from the group consisting of wash gloves, mittens, and back scrubbers.

8. A multi-phase hygienic cleansing system, comprising:
a washcloth; and
a woven polymer mesh sheet attached to and substantially covering one major surface of said washcloth, wherein an interior space is defined between said washcloth and said woven polymer mesh sheet.

9. The multi-phase hygienic cleansing system of claim 8, wherein said woven polymer mesh sheet defines a balance of apertures and surface area.

10. The multi-phase hygienic cleansing system of claim 8, wherein said washcloth comprises a first phase with a first external surface area, and said woven polymer mesh sheet comprises a second phase with a second external surface area, wherein said first phase and said second phase are attached together to define a plexus system.

11. The multi-phase hygienic cleansing system of claim 8, wherein said woven polymer mesh sheet comprises porthole polyester.

12. The multi-phase hygienic cleansing system of claim 8, wherein said washcloth comprises terry cloth.

13. The multi-phase hygienic cleansing system of claim 8, wherein said washcloth comprises microfiber.

14. The multi-phase hygienic cleansing system of claim 8, wherein said washcloth comprises chamois.

15. The multi-phase hygienic cleansing system of claim 8, wherein said interior space, defined between said washcloth and said woven polymer mesh sheet, is defined by peripheral edges of said washcloth and said woven polymer mesh sheet, wherein a plurality of entries into said interior space is defined by said apertures of said woven polymer mesh sheet, and wherein a barrier for said interior space is defined by said washcloth.

16. The multi-phase hygienic cleansing system of claim 15, wherein each of said plurality of entries into said interior space is configured to facilitate passage of dead skin cells and debris from a location external to said cleansing system to said interior space.

17. The multi-phase hygienic cleansing system of claim 8, wherein said washcloth and said woven polymer mesh sheet are sewn together about their respective peripheral edges.
